(19) United States
(12) Patent Application Publication
(10) Pub. No.: US 2022/0252942 A1
(43) Pub. Date: Aug. 11, 2022

(54) DISPLAY PANEL AND MANUFACTURING METHOD THEREFOR, AND DISPLAY APPARATUS

(71) Applicants: BEIJING BOE DISPLAY TECHNOLOGY CO., LTD., Beijing (CN); BOE Technology Group Co., Ltd., Beijing (CN)

(72) Inventors: Feifei WANG, Beijing (CN); Hongming ZHAN, Beijing (CN); Xibin SHAO, Beijing (CN)

(21) Appl. No.: 17/627,691

(22) PCT Filed: Mar. 8, 2021
(86) PCT No.: PCT/CN2021/079584

§ 371 Date: Jan. 17, 2022

(30) Foreign Application Priority Data
May 13, 2020 (CN) 202010403312.2

(51) Int. Cl. G02F 1/13363; G02F 1/1335; G03F 7/00

(52) U.S. Cl. CPC G02F 1/133633; G02F 1/133516; G03F 7/0007; G02F 2413/08; G02F 2413/03; G02F 2413/07; G02F 2413/13

(57) ABSTRACT

A display panel, including an array substrate and an opposite substrate that are arranged opposite to each other, and a liquid crystal layer. A color filter layer and a compensation layer are provided on the array substrate or the opposite substrate; the color filter layer includes n color filter units that are periodically arranged; the compensation layer includes n compensation units; and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color. Further disclosed are a display apparatus including the display panel, and a manufacturing method for the display panel.

### CROSS-REFERENCE TO RELATED APPLICATIONS

This application is a national stage application of PCT Application No. PCT/CN2021/079584, filed on Mar. 8, 2021, which claims priority of Chinese Patent Application No. 202010403312.2, filed to the CNIPA on May 13, 2020, and entitled “Display Panel and Manufacturing Method Therefor, and Display Apparatus”, the contents of which should be interpreted as being hereby incorporated by reference.

### TECHNICAL FIELD

Embodiments of the present disclosure relate to, but are not limited to, the field of display technologies, and particularly relates to a display panel, a manufacturing method therefor, and a display apparatus.

### BACKGROUND

Liquid Crystal Display (LCD) has advantages such as small size, low power consumption and no radiation, and has developed rapidly in recent years. The main structure of LCD includes a Thin Film Transistor (TFT) array substrate and a Color Filter (CF) substrate, and the Liquid Crystal (LC) molecules are filled between the array substrate and the color filter substrate. By controlling the common electrode and the pixel electrode, an electric field is formed to drive the liquid crystal to deflect, and gray tone display is realized. According to display modes, LCD can be divided into Twisted Nematic (TN) display mode, Vertical Alignment (VA) display mode, In Plane Switching (IPS) display mode, and Advanced Super Dimension Switch (ADS) display mode, etc. Among them, ADS and IPS are horizontal electric field display devices, which have the advantages of wide viewing angle, high aperture ratio, high penetration rate, high display resolution, fast response speed, low power consumption, low chromatic aberration, and so on.

Nowadays, horizontal electric field display devices have problems such as light leakage, being empurpled and color cast in dark state, which not only affect the product quality, but affect the application of ADS display mode in curved products.

### SUMMARY

The following is a summary about the subject matter described in the present disclosure in detail. The summary is not intended to limit the scope of protection of the claims.

An embodiment of the present disclosure provides a display panel, which includes: an array substrate and an opposite substrate that are arranged opposite to each other, and a liquid crystal layer provided between the array substrate and the opposite substrate; a color filter layer and a compensation layer are provided on the array substrate or the opposite substrate; the color filter layer includes n color filter units that are periodically arranged, the compensation layer includes n compensation units that are periodically arranged, and the direction of the optical axis of the n compensation units is parallel to the direction of the initial optical axis of the liquid crystal molecules in the liquid crystal layer; and the ith color filter unit is configured to filter out the light of an ith color, wherein the position of an ith compensation unit corresponds to the position of an ith color filter unit, and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color; n is a positive integer greater than 2, and i=1, 2, . . . , n.

Optionally, the color filter layer is arranged on a side of the array substrate facing the opposite substrate, or the color filter layer is arranged on a side of the opposite substrate facing the array substrate.

Optionally, the compensation layer is arranged on a side of the array substrate facing the opposite substrate, or the compensation layer is arranged on a side of the opposite substrate facing the array substrate.

Optionally, the color filter layer is arranged on a side of the opposite substrate facing the array substrate, and the compensation layer is arranged on a side of the color filter layer facing the array substrate, or, the compensation layer is arranged on a side of the opposite substrate facing the array substrate, and the color filter layer is arranged on a side of the compensation layer facing the array substrate.

Optionally, the compensation layer includes a positive double zigzag uniaxial plate.

Optionally, the materials of the positive double zigzag uniaxial plate include: 20% to 45% by weight of liquid crystal, 5% to 35% by weight of liquid crystal polymerized monomer, 0.05% to 19.5% by weight of polymerized monomer and 0.05% to 0.5% by weight of initiator; alternatively, the material of the positive double zigzag uniaxial plate includes: 20% to 39.5% by weight of liquid crystal, 5% to 20% by weight of liquid crystal polymerized monomer, 5% to 20% by weight of ultraviolet polymerized monomer, 5% to 20% by weight of thermally polymerized monomer and 0.05% to 0.5% by weight of initiator.

Optionally, the n color filter units include a red color filter unit that filters out red light, a green color filter unit that filters out green light, and a blue color filter unit that filters out blue light; the n compensation units include a first compensation unit corresponding to the position of the red color filter unit, a second compensation unit corresponding to the position of the green color filter unit and a third compensation unit corresponding to the position of the blue color filter unit; the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.

Optionally, in a direction perpendicular to the display panel, the thicknesses of the first compensation unit, the second compensation unit, and the third compensation unit are the same; the refractive index difference of the first compensation unit is greater than the refractive index difference of the second compensation unit, and the refractive index difference of the second compensation unit is greater than the refractive index difference of the third compensation unit.

Optionally, the refractive index differences of the first compensation unit, the second compensation unit, and the third compensation unit are the same, and in the direction perpendicular to the display panel, the thickness of the first compensation unit is greater than the thickness of the second compensation unit, and the thickness of the second compensation unit is greater than the thickness of the third compensation unit.

An embodiment of the present disclosure further provides a display apparatus, including a display panel described above.

An embodiment of the present disclosure further provides a manufacturing method for a display panel, including: respectively manufacturing an array substrate and an opposite substrate, wherein a color filter layer and a compensation layer are formed on the array substrate or the opposite substrate; and forming a liquid crystal layer between the array substrate and the opposite substrate. The color filter layer includes n color filter units that are periodically arranged; the compensation layer includes n compensation units that are periodically arranged; and the direction of the optical axis of the n compensation units is parallel to the direction of the initial optical axis of the liquid crystal molecules in the liquid crystal layer; and the ith color filter unit is configured to filter out the light of an ith color, wherein the position of an ith color filter unit corresponds to the position of an ith compensation unit; and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color; n is a positive integer greater than 2, and i=1, 2, . . . , n.

Optionally, the color filter layer and the compensation layer are formed on the opposite substrate, and manufacturing the opposite substrate includes: sequentially manufacturing a color filter layer and a compensation layer on the opposite substrate, or sequentially manufacturing a compensation layer and a color filter layer on the opposite substrate.

Optionally, manufacturing the compensation layer includes: forming a polymer liquid crystal composite film, forming a liquid crystal polymer layer by heating or ultraviolet irradiation, and exposing and developing the liquid crystal polymer layer by using a mask plate to form a first compensation unit; coating a polymer liquid crystal composite film containing ultraviolet polymerized monomer and thermally polymerized monomer, and irradiating the polymer liquid crystal composite film with ultraviolet light by using a mask plate to form a second compensation unit; and setting the opposite substrate on a heating pedestal or in an oven, and heating the polymer liquid crystal composite film to form a third compensation unit.

Optionally, the n color filter units include a red color filter unit, a green color filter unit, and a blue color filter unit; the n compensation units include a first compensation unit corresponding to the position of the red color filter unit, a second compensation unit corresponding to the position of the green color filter unit and a third compensation unit corresponding to the position of the blue color filter unit; the phase retardation of the red light passing through the first compensation unit is greater than the phase retardation value of the green light passing through the second compensation unit, and the phase retardation of the green light passing through the second compensation unit is greater than the phase retardation of the blue light passing through the third compensation unit.

Optionally, in a direction perpendicular to the display panel, the thicknesses of the first compensation unit, the second compensation unit, and the third compensation unit are the same; the refractive index difference of the first compensation unit is greater than the refractive index difference of the second compensation unit, and the refractive index difference of the second compensation unit is greater than the refractive index difference of the third compensation unit; or, the refractive index differences of the first compensation unit, the second compensation unit, and the third compensation unit are the same, and in the direction perpendicular to the display panel, the thickness of the first compensation unit is greater than the thickness of the second compensation unit, and the thickness of the second compensation unit is greater than the thickness of the third compensation unit.

After reading and understanding the drawings and the detailed description, other aspects may be understood.

### BRIEF DESCRIPTION OF DRAWINGS

The drawings are used to provide a further understanding of the technical solution of the present disclosure, constitute a part of the description, are used together with the embodiments of the present disclosure to explain the technical solution of the present disclosure, and do not constitute limitations to the technical solution of the present disclosure. The shapes and sizes of each component in the drawings do not reflect the true scale and are only intended to schematically describe the contents of the present disclosure.

FIG. 1 is a schematic diagram of a structure of a display panel according to an embodiment of the present disclosure.

FIG. 2 is a schematic diagram after a pattern of a black matrix is formed according to an embodiment of the present disclosure.

FIG. 3 is a schematic diagram after a pattern of a color filter layer is formed according to an embodiment of the present disclosure.

FIG. 4 is a schematic diagram after a first compensation unit is formed according to an embodiment of the present disclosure.

FIG. 5 is a schematic diagram after a second compensation unit is formed according to an embodiment of the present disclosure.

FIG. 6 is a schematic diagram after a third compensation unit is formed according to an embodiment of the present disclosure.

FIG. 7 is a schematic diagram after a polymer liquid crystal composite film is coated according to an embodiment of the present disclosure.

FIG. 8 is a schematic diagram after a second compensation unit is formed according to an embodiment of the present disclosure.

FIG. 9 is a schematic diagram after a third compensation unit is formed according to an embodiment of the present disclosure.

FIG. 10 is a schematic diagram of another structure of a display panel according to an embodiment of the present disclosure.

FIG. 11 is a schematic diagram of yet another structure of a display panel according to an embodiment of the present disclosure.

FIG. 12 is a schematic diagram of yet another structure of a display panel according to an embodiment of the present disclosure.

### DETAILED DESCRIPTION

To make the objects, technical solutions and advantages of the present disclosure more clear, embodiments of the present disclosure will be described in detail below with reference to the drawings. The implementation modes may be implemented in various forms. Those of ordinary skill in the art can easily understand such a fact that manners and contents may be transformed into various forms without departing from the purpose and scope of the present disclosure. Therefore, the present disclosure should not be explained as being limited to the contents recorded in the following implementations only. The embodiments in the present disclosure and the features in the embodiments can be freely combined without conflicts.

In the drawings, sometimes for clarity, the size of the constituent elements, the thickness of the layer or the area may be exaggerated. Therefore, implementations of the present disclosure are not necessarily limited to the sizes, and the shapes and magnitudes of the components in the drawings do not reflect true proportions. In addition, the drawings schematically show ideal examples, and implementations of the present disclosure are not limited to the shapes or values shown in the drawings.

“First”, “second”, “third” and other ordinal numerals in the specification are set to avoid the confusion of the constituent elements, rather than to limit the quantity.

For convenience, in the specification the terms such as “middle”, “up”, “down”, “front”, “back”, “vertical”, “horizontal”, “top”, “bottom”, “inside” and “outside” indicating the orientation or position relationship are used to describe the position relationship between the constituent elements with reference to the drawings, only for the convenience of describing the specification and simplifying the description, instead of indicating or implying that the device or element referred to must have a specific orientation or be constructed and operated in a specific orientation, so they should not be understood as limitations to the present disclosure. The position relationship between the constituent elements may be appropriately varied according to the direction of the described constituent elements. Therefore, appropriate replacements based on situations are allowed, not limited to the expressions in the specification.

Unless otherwise specified and limited, in the specification the terms “mount”, “connected” and “connect” should be understood in a broad sense. For example, it may be fixed connection, removable connection, or integrated connection; it may be mechanical connection or electrical connection; it may be direct connection, indirect connection through an intermediate component, or communication inside two components. For those skilled in the art, the meanings of the above terms in the present disclosure may be understood according to the situation.

In the specification, a transistor refers to a component which at least includes three terminals, i.e., a gate electrode, a drain electrode and a source electrode. The transistor has a channel region between the drain electrode (drain electrode terminal, drain region, or drain) and the source electrode (source electrode terminal, source region, or source), and a current may flow through the drain electrode, the channel region, and the source electrode. In this specification, the channel region refers to a region which the current mainly flows through.

In this specification, it may be the case that a first electrode is a drain electrode and a second electrode is a source electrode, and it may also be the case that a first electrode is a source electrode and a second electrode is a drain electrode. In cases that transistors with opposite polarities are used, or a current direction changes during work of a circuit, or the like, functions of the “source electrode” and the “drain electrode” may sometimes be exchanged. Therefore, the “source electrode” and the “drain electrode” may be exchanged in the present specification.

In this specification, an “electrical connection” includes a case where constituent elements are connected together through an element with a certain electric action. “The element with the certain electric action” is not particularly limited as long as electric signals between the connected composition elements may be sent and received. Examples of the “element with a certain electric action” may include not only electrodes and wirings, but also switching elements such as transistors, resistors, inductors, capacitors, and other elements having various functions.

In this specification, “parallel” may refer to a state in which two straight lines form an angle between −10 degrees and 10 degrees and for example, includes a state in which the angle is between −5 degrees and 5 degrees. In addition, “perpendicular” may refer to a state that an angle formed by two straight lines is larger than 80 degrees and smaller than 100 degrees, and for example may include a state that the angle is larger than 85 degrees and smaller than 95 degrees.

In this specification, “film” and “layer” may be interchangeable. For example, sometimes “conducting layer” may be replaced by “conducting film”. Similarly, sometimes “insulating film” may be replaced by “insulating layer”.

At present, a horizontal electric field display panel tends to have serious problems such as light leakage, empurple and color cast in dark state when being bent or pressed. Taking the LCD of ADS display mode as an example, the display panel includes an array substrate, an opposite substrate and a liquid crystal layer between the array substrate and the opposite substrate, and the liquid crystal molecules in the liquid crystal layer have an initial optical axis in the horizontal direction. In order to ensure regular display, the outer sides of the array substrate and the opposite substrate are respectively provided with a first polarizer and a second polarizer with mutually perpendicular light transmission axes. Since the liquid crystal cannot emit light, the display panel is further provided with a backlight source, and the light emitted by the backlight source passes through the first polarizer, the array substrate, the liquid crystal layer, the opposite substrate and the second polarizer in turn. In the case that no voltage is applied, the liquid crystal does not distort the light. If the polarization direction of the light after passing through the first polarizer and the liquid crystal is perpendicular to the light transmission axis direction of the second polarizer, the light cannot be transmitted, and a dark picture is thereby displayed and the display panel is in a dark state. In the case that voltage is applied, the liquid crystal molecules spin to twist the light, changing the polarization direction of the light, so that the light can be emitted through the second polarizer, and a bright picture is thereby displayed and the display panel is in a bright state. The array substrate and the base substrate of the opposite substrate are often made of glass, which has birefringence effect on light. When the display panel is stressed by bending or pressing, the glass changes from isotropic medium to optically anisotropic medium and will produce uneven stress birefringence according to different stress conditions, and the polarization state of light passing through the glass will change. Generally, the polarization state generated by the base substrate of the array substrate is equal in phase and opposite in direction to the polarization state generated by the base substrate of the opposite substrate. Without the liquid crystal layer, the polarization states generated by the two substrate substrates can be offset. However, due to the existence of the liquid crystal layer, the phase difference is amplified by the liquid crystal, which causes the polarization states generated by the two substrate substrates to be unable to offset each other, resulting in dark state (LO) light leakage, empurple and color cast problems.

An embodiment of the present disclosure provides a display panel. A display panel of an embodiment of the present disclosure may include: an array substrate and an opposite substrate that are arranged opposite to each other, a liquid crystal layer provided between the array substrate and the opposite substrate, a color filter layer and a compensation layer; the color filter layer may include n color filter units that are periodically arranged, the compensation layer may include n compensation units that are periodically arranged, and the direction of the optical axis of the n compensation units is parallel to the direction of the initial optical axis of the liquid crystal molecules in the liquid crystal layer; and the ith color filter unit is configured to filter out the light of an ith color, wherein the position of an ith compensation unit corresponds to the position of an ith color filter unit, and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color; n is a positive integer greater than 2, and i=1, 2, . . . , n. Therefore, the display panel in the embodiment of the present disclosure can avoid the problems with dark light leakage, empurple and color cast.

In an exemplary embodiment, the color filter layer may be arranged on a side of an array substrate facing an opposite substrate, or the color filter layer may be arranged on a side of the opposite substrate facing the array substrate.

In an exemplary embodiment, the compensation layer may be arranged on a side of an array substrate facing an opposite substrate, or the compensation layer may be arranged on a side of the opposite substrate facing the array substrate.

In an exemplary embodiment, the color filter layer can be arranged on a surface of an opposite substrate facing an array substrate, and the compensation layer is arranged on a surface of the color filter layer facing the array substrate; alternatively, the compensation layer can be arranged on the surface of the opposite substrate facing the array substrate, and the color filter layer is arranged on the surface of the compensation layer facing the array substrate.

In an exemplary embodiment, n color filter units may include a red color filter unit that filters out red (R) light, a green color filter unit that filters out green (G) light, and a blue color filter unit that filters out blue (B) light. And n compensation units may include a first compensation unit corresponding to the position of the red color filter unit, a second compensation unit corresponding to the position of the green color filter unit and a third compensation unit corresponding to the position of the blue color filter unit. Among them, the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit. In some possible implementations, the n color filter units may include red color filter units, green color filter units, blue color filter units, and white (W) color filter units.

In an exemplary embodiment, the compensation layer may include a positive double zigzag uniaxial plate (+A plate).

In an exemplary embodiment, the display panel may be a horizontal electric field type display panel. For example, the display mode of the display panel may be ADS display mode or IPS display mode.

In an exemplary embodiment of the present disclosure, the sum of the phase retardation of the ith compensation unit and the phase retardation of the liquid crystal layer may not be strictly in accordance with the integer multiple of the ith color light, and there may be a certain tolerance range, for example, within 20%, which is all within the protection range of the present disclosure. The optical axis direction of the ith compensation unit and the initial optical axis direction of the liquid crystal molecules in the liquid crystal layer are parallel to each other, and there may be a certain tolerance range, for example, within 11 degrees, which are all within the protection range of the present disclosure; i=1, 2 or 3.

The display panel of the embodiment of the present disclosure may be implemented in various ways, and the technical solution of the embodiment of the present disclosure will be explained in detail by the exemplary embodiments below.

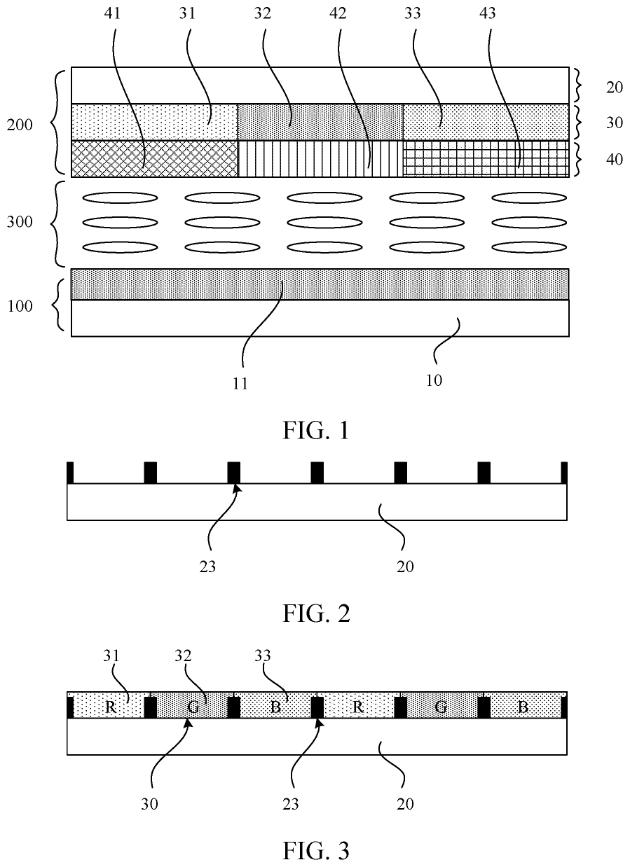

FIG. 1 is a schematic diagram of a structure of a display panel according to an exemplary embodiment of the present disclosure. In FIG. 1, a structure in which a color filter layer and a compensation layer are arranged on one side of an opposite substrate is illustrated. As shown in FIG. 1, the display panel may include an array substrate 100 and an opposite substrate 200 that are arranged opposite to each other, and a liquid crystal layer 300 provided between the array substrate 100 and the opposite substrate 200. The array substrate 100 may include an array substrate 10 and an array structure layer 11 arranged on a side surface of the array substrate 10 facing the opposite substrate 200. The opposite substrate 200 may include the opposite substrate 20, a color filter layer 30 arranged on the surface of the opposite substrate 20 facing the array substrate 100, and a compensation layer 40 arranged on the surface of the color filter layer 30 facing the array substrate 100, wherein the color filter layer 30 is configured to filter out light of corresponding colors, and the compensation layer 40 is configured to perform phase compensation on the light of corresponding colors. The display panel may further include an array polarizer, an opposite polarizer, and a backlight source (not shown), wherein the array polarizer is arranged on the surface of the array substrate 100 away from the opposite substrate 200, the opposite polarizer is arranged on the surface of the opposite substrate 200 away from the array substrate 100, the light transmission axis of the array polarizer and the light transmission axis of the opposite polarizer are perpendicular to each other, and the backlight is arranged on the side of the array polarizer away from the array substrate 100. The light emitted from the backlight source sequentially passes through the array polarizer, array base substrate 10, array structure layer 11, liquid crystal layer 300, compensation layer 40, color filter layer 30, opposite substrate 20 and opposite polarizer, and the initial optical axis direction of liquid crystal molecules in the liquid crystal layer 300 is horizontal.

In an exemplary embodiment, the color filter layer 30 may include a first color filter unit 31, a second color filter unit 32 and a third color filter unit 33 arranged periodically. The first color filter unit 31 is configured to filter the light passing through the first color filter unit 201 to filter out the light of the first color. The second color filter unit 32 is configured to filter the light passing through the second color filter unit 32 to filter out the second color light. The third color filter unit 33 is configured to filter the light passing through the third color filter unit 33 to filter out the third color light.

In an exemplary embodiment, the compensation layer 40 may include a first compensation unit 41, a second compensation unit 42 and a third compensation unit 43 which are periodically arranged. The first compensation unit 41 corresponds to the position of the first color filter unit 31 and is configured to phase compensate the first color light passing through the first compensation unit 41, so that the sum of the phase retardation of the first color light passing through the first compensation unit 41 and the phase retardation of the first color light passing through the liquid crystal layer 300 is an integer multiple of the wavelength of the first color light. The second compensation unit 42 corresponds to the position of the second color filter unit 32 and is configured to phase compensate the second color light passing through the second compensation unit 42, so that the sum of the phase retardation of the second color light passing through the second compensation unit 42 and the phase retardation of the second color light passing through the liquid crystal layer 300 is an integer multiple of the wavelength of the second color light. The third compensation unit 43 corresponds to the position of the third color filter unit 33 and is configured to phase compensate the third color light passing through the third compensation unit 43, so that the sum of the phase retardation of the third color light passing through the third compensation unit 43 and the phase retardation of the third color light passing through the liquid crystal layer 300 is an integer multiple of the wavelength of the third color light.

Light travels slowly in substances with high refractive index and faster in substances with low refractive index. Because liquid crystal has optical birefringence, the refractive index of liquid crystal includes regular (ordinary light) refractive index n0 and irregular (extraordinary light) refractive index ne respectively, so when light passes through the liquid crystal layer with refractive index difference in XY direction, the traveling distance of light in XY direction will be different, and this difference value is Phase Retardation, or phase difference. Among them, X refers to the X-axis direction in the liquilightd crystal plane, and Y refers to the Y-axis direction perpendicular to the X-axis in the liquid crystal plane. According to the phase retardation calculation formula, the in-plane phase retardation RLC of the liquid crystal layer 300=(ne−n0)*d2, wherein d2 is the thickness of the liquid crystal layer 300 perpendicular to the direction of the display panel, n0 is the regular refractive index of the liquid crystal, and ne is the irregular refractive index of the liquid crystal.

In an exemplary embodiment, the compensation layer 40 can be a positive double zigzag uniaxial (+A) plate, also known as +A compensation film layer, which satisfies nx>ny=nz, where nx is the refractive index in the X-axis direction in the +A plate, ny is the refractive index in the Y-axis direction perpendicular to the X-axis in the +A plate, and nz is the refractive index in the thickness direction of the +A plate. According to the phase retardation calculation formula, the in-plane phase retardation of the compensation layer 40 is expressed as R+A=(NX−NY)*d1, where d1 is the thickness of the compensation layer 40 perpendicular to the direction of the display panel. In this way, the sum of the phase retardation of the incident light passing through the +A plate and the phase retardation of the incident light passing through the liquid crystal layer is an integer multiple of the wavelength of the incident light, which can be expressed as: R+A+RLC=m*λ, m=0, 1, 2 . . . , where λ is the wavelength of the incident light. By adjusting the material characteristics (nx or ny) or thickness parameter (d1) of the +A plate to satisfy (nx−ny)*d1=m*λ−(ne−n0)*d2, the +A plate can compensate the in-plane phase retardation caused by light passing through the liquid crystal layer when the optical axis direction of the +A plate is parallel to the initial optical axis direction of liquid crystal molecules in the liquid crystal layer. In some possible implementations, the +A board can use liquid crystal composite film to reduce the manufacture cost.

In an exemplary embodiment, the first color filter unit 31 may be a red color filter unit configured to filter out red light, the second color filter unit 32 may be a green color filter unit configured to filter out green light and the third color filter unit 33 may be a blue color filter unit configured to filter out blue light.

In an exemplary embodiment, the first compensation unit 41 corresponds to the position of the red color filter unit, and the in-plane phase retardation of the first compensation unit 41 is expressed as R+AR=(nxR−nyR)*d1R, where d1R is the thickness of the first compensation unit 41 perpendicular to the direction of the display panel. In this way, by adjusting the material characteristics (nxR or nyR) or the thickness parameter (d1R) of the first compensation unit 41 to make R+AR+RLC=m*λR, m=0, ±1, ±2 . . . , that is, satisfies (nxR−nyR)*d1R+(ne-n0)*d2=m*λR, where λR is the wavelength of red light, the in-plane phase retardation generated by the red light passing through the liquid crystal layer 300 can be compensated when the optical axis direction of the first compensation unit 41 is parallel to the initial optical axis direction of the liquid crystal molecules in the liquid crystal layer.

In an exemplary embodiment, the second compensation unit 42 corresponds to the position of the green color filter unit, and the in-plane phase retardation of the second compensation unit 42 is G+AG=(nxG−nyG)*d1G, where d1G is the thickness of the second compensation unit 42 perpendicular to the direction of the display panel. In this way, by adjusting the material characteristics (nxG or nyG) or the thickness parameter (d1G) of the second compensation unit 42 to make G+AG+GLC=m*λG, m=0, ±1, ±2 . . . , that is, satisfies (nxG−nyG)*d1G+(ne−n0)*d2=m*λG, where λG is the wavelength of green light, the in-plane phase retardation generated by the green light passing through the liquid crystal layer 300 can be compensated when the optical axis direction of the second compensation unit 42 is parallel to the initial optical axis direction of the liquid crystal molecules in the liquid crystal layer.

In an exemplary embodiment, the third compensation unit 43 corresponds to the position of the blue color filter unit, and the in-plane phase retardation of the third compensation unit 43 is B+AB=(nxB−nyB)*d1B, where d1B is the thickness of the third compensation unit 43 perpendicular to the direction of the display panel. In this way, by adjusting the material characteristics (nxB or nyB) or the thickness parameter (d1B) of the third compensation unit 43 to make B+AB+BLC=m*kB, m=0, ±1, ±2 . . . , that is, satisfies (nxB−nyB)*d1B+(ne−n0)*d2=m*kB, where λB is the wavelength of green light, the in-plane phase retardation generated by the blue light passing through the liquid crystal layer 300 can be compensated when the optical axis direction of the third compensation unit 43 is parallel to the initial optical axis direction of the liquid crystal molecules in the liquid crystal layer.

In an exemplary embodiment, the integer multiple may be 1, that is, the sum of the phase retardation of the first compensation unit 41 and the phase retardation of the liquid crystal layer is the wavelength of red light, the sum of the phase retardation of the second compensation unit 42 and the phase retardation of the liquid crystal layer is the wavelength of green light, and the sum of the phase retardation of the third compensation unit 43 and the phase retardation of the liquid crystal layer is the wavelength of blue light, which can reduce the thicknesses of the first compensation unit 41, the second compensation unit 42 and the third compensation unit 43 as much as possible, which is conducive to the thinning of the display panel.

In an exemplary embodiment, the wavelength of red light can be set to 605 nm to 700 nm, the wavelength of green light can be set to 505 nm to 600 nm, the wavelength of blue light can be set to 400 nm to 500 nm, and the phase retardations of the first compensation unit 41, the second compensation unit 42 and the third compensation unit 43 can be set to 50 nm to 400 nm. Because the material characteristics and thickness of the liquid crystal layer are constant, the phase retardation of the +A plate is different for different wavelengths of incident light. Since the wavelength of the red light is greater than the wavelength of the green light and the wavelength of the green light is greater than the wavelength of the blue light, the phase retardation R+AR of the red light passing through the first compensation unit 41 is greater than the phase retardation R+AG of the green light passing through the second compensation unit 42, and the phase retardation R+AG of the green light passing through the second compensation unit 42 is greater than the phase retardation R+AB of the blue light passing through the third compensation unit 43.

In an exemplary embodiment, it is possible to set the thickness of the three compensation units to be the same, that is, d1R=d1G=d1B, and set the refractive index difference (nxR-nyR) of the first compensation unit 41 to be larger than the refractive index difference (nxG−nyG) of the second compensation unit 42, which is set to be larger than the refractive index difference (nxB−nyB) of the third compensation unit 43 to achieve the phase retardation R+AR of the red light passing through the first compensation unit 41 is greater than the phase retardation R+AG of the green light passing through the second compensation unit 42, and the phase retardation R+AG of the green light passing through the second compensation unit 42 is greater than the phase retardation R+AB of the blue light passing through the third compensation unit 43.

In an exemplary embodiment, it is possible to set the refractive index difference of the three compensation units to be the same, that is, nxR−nyR=nxG−nyG=nxB-nyB, and set the thickness d1R of the first compensation unit 41 to be greater than the thickness d1G of the second compensation unit 42, and the thickness d1G of the second compensation unit 42 to be greater than the thickness d1B of the third compensation unit 43 to achieve the phase retardation R+AR of the red light passing through the first compensation unit 41 is greater than the phase retardation R+AG of the green light passing through the second compensation unit 42, and the phase retardation R+AG of the green light passing through the second compensation unit 42 is greater than the phase retardation R+AB of the blue light passing through the third compensation unit 43.

In some possible implementations, the thickness and refractive index difference of the three compensation units can be set to be different. Adjusting the refractive index difference and thickness can achieve the phase retardation R+AR of the red light passing through the first compensation unit 41 is greater than the phase retardation R+AG of the green light passing through the second compensation unit 42, and the phase retardation R+AG of the green light passing through the second compensation unit 42 is greater than the phase retardation R+AB of the blue light passing through the third compensation unit 43.

The structure of the display panel will now be described through an example of a manufacturing process of the display panel. A “patterning process” mentioned in the present disclosure includes film layer deposition, coating with a photoresist, masking, exposure, development, etching, photoresist stripping, and other treatment. Deposition may be any one or more of sputtering, evaporation, and chemical vapor deposition. Coating may be any one or more of spray coating and spin coating. Etching may be any one or more of dry etching and wet etching. “Thin film” refers to a layer of thin film made from a certain material on a substrate by a deposition or coating process. If the “thin film” does not require a patterning process throughout the manufacturing process, the “thin film” may be referred to as a “layer”. When the patterning process is needed by the “thin film” in the whole making process, the thin film is called a “thin film” before the patterning process and called a “layer” after the patterning process. The “layer” after the patterning process includes at least one “pattern”. In the present disclosure, “A and B are provided on the same layer” means that A and B are formed at the same time by the same patterning process.

The process for manufacturing of the display panel in this disclosed embodiment mainly includes two parts, the first part includes substrate manufacture, and the second part includes alignment pressing (cell alignment). Among them, substrate manufacture includes array substrate manufacture and opposite substrate manufacture, which have no order requirement and can be carried out simultaneously. The following describes the two-part processing acts respectively.

I. Manufacture of Array Substrate in Part I

The array substrate of this embodiment includes an array substrate and a driving structure layer arranged on the array substrate, and the main structure of the driving structure layer includes a thin film transistor, a pixel electrode and a common electrode. In this embodiment, the process of forming the driving structure layer can adopt the mature process of manufacturing LCD. In an exemplary embodiment, the process of forming the driving structure layer may include: (1) gate lines, gate electrodes and common electrode patterns are formed on the array substrate. (2) A gate insulating layer covering the gate line, the gate electrode and the common electrode, and an active layer arranged on the gate insulating layer are formed. (3) A data line, a source electrode and a drain electrode are formed, wherein a conductive channel is formed between the source electrode and the drain electrode. (4) A passivation layer covering the data line, the source electrode and the drain electrode is formed, on which a via exposing the drain electrode is provided. (5) A pixel electrode is formed on the passivation layer, wherein the pixel electrode is connected to the drain electrode through a via on the passivation layer. The common electrode is configured to provide a common voltage, and the pixel electrode is configured to provide a pixel voltage for display. One of the common electrode and the pixel electrode is a plate electrode and the other is a slit electrode, and the multi-dimensional electric field generated between the slit electrode and the plate electrode drives the liquid crystal to deflect. In some possible implementations, the method for manufacturing the array substrate can also include forming an alignment film and performing rubbing treatment on the alignment film.

II. Manufacture of Opposite Substrate in Part I

(1) A black matrix pattern is manufactured, including: a black matrix film is coated on the opposite substrate 20, the black matrix film is exposed with a mask plate, and the pattern of black matrices 23 arranged at intervals are formed on the opposite substrate 20 after development, as shown in FIG. 2.

(2) A color filter layer pattern is manufactured, including: a color filter layer 30 pattern is formed on the opposite substrate 20 on which the pattern of the black matrices 23 is formed. The color filter layer 30 pattern includes a red film units 31, a green film units 32 and a blue film units 33. The red film units 31, green film units 32 and blue film units 33 are respectively arranged between the black matrices 23 and periodically arranged according to a set rule, as shown in FIG. 3. In an exemplary embodiment, the pattern of the color filter layer 30 can be manufactured by relevant mature manufacture processes. In some possible implementations, after forming the color filter layer 30, a planarization layer (OC) may be formed.

(3) A compensation layer pattern is manufactured. In this embodiment, a variety of manufacturing methods can be used to form the compensation layer, which will be described below with three manufacturing methods as examples.

A first method for manufacturing a compensation layer may include: Step (311), Step (312) and Step (313).

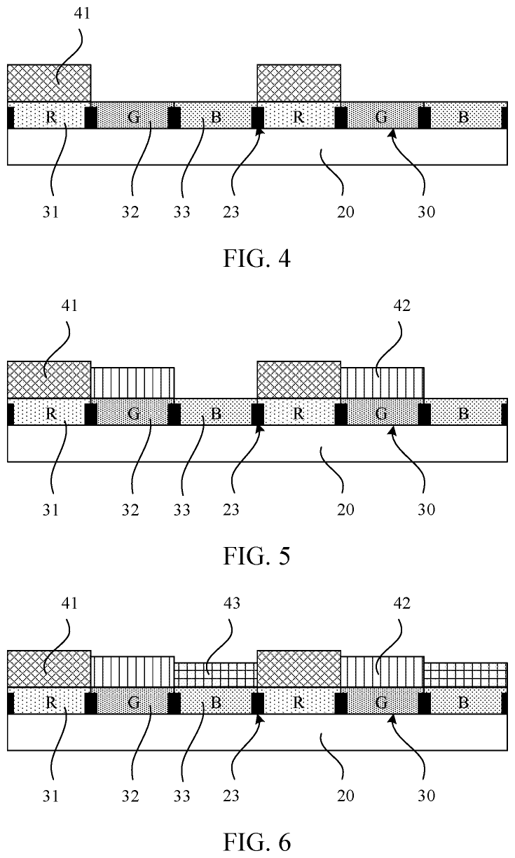

(311) A polymer liquid crystal composite film is coated on the opposite substrate 20 with the above structure, and the polymer liquid crystal composite film is heated or ultraviolet irradiated to polymerize the liquid crystal molecules in the polymer liquid crystal composite film to form the first liquid crystal polymer layer. Then, the first liquid crystal polymer layer is exposed and developed by using a mask plate, and the first compensation units 41 arranged at intervals are formed on the opposite substrate 20, as shown in FIG. 4. In this embodiment, the first compensation unit 41 corresponds to the position of the red color filter unit, that is, an orthographic projection of the first compensation unit 41 on the opposite substrate 20 includes an orthographic projection of the red color filter unit on the opposite substrate 20. By adjusting the thickness of the polymer liquid crystal composite film, the phase retardation of the red light passing through the first compensation unit 41 can be adjusted so that the sum of the phase retardation of the red light passing through the first compensation unit 41 and the phase retardation of the red light passing through the liquid crystal layer in the display panel is an integer multiple of the wavelength of the red light.

(312) A polymer liquid crystal composite film is coated, a second liquid crystal polymer layer is formed by heating or ultraviolet light irradiation treatment, and the second liquid crystal polymer layer is exposed and developed using a mask plate, and second compensation units 42 arranged at intervals are formed on the opposite substrate 20, as shown in FIG. 5. In this embodiment, the second compensation unit 42 corresponds to the position of the green color filter unit, that is, an orthographic projection of the second compensation unit 42 on the opposite substrate 20 includes an orthographic projection of the green color filter unit on the opposite substrate 20. By adjusting the thickness of the polymer liquid crystal composite film, the phase retardation of the green light passing through the second compensation unit 42 can be adjusted so that the sum of the phase retardation of the green light passing through the second compensation unit 42 and the phase retardation of the green light passing through the liquid crystal layer in the display panel is an integer multiple of the wavelength of the green light. In an exemplary embodiment, the material of the first liquid crystal polymer layer is the same as the material of the second liquid crystal polymer layer. Since the wavelength of red light is larger than the wavelength of green light, the thickness of the first compensation unit 41 can be set to be larger than the thickness of the second compensation unit 42, and the thickness of the first compensation unit 41 can be 0.5 μm to 3.0 μm.

(313) A polymer liquid crystal composite film is coated, a third liquid crystal polymer layer is formed by heating or ultraviolet light irradiation treatment, and the third liquid crystal polymer layer is exposed and developed using a mask plate, and third compensation units 43 arranged at intervals are formed on the opposite substrate 20, as shown in FIG. 6. In this embodiment, the third compensation unit 43 corresponds to the position of the blue color filter unit, that is, an orthographic projection of the third compensation unit 43 on the opposite substrate 20 includes an orthographic projection of the blue color filter unit on the opposite substrate 20. By adjusting the thickness of the polymer liquid crystal composite film, the phase retardation of the blue light passing through the third compensation unit 43 can be adjusted so that the sum of the phase retardation of the blue light passing through the third compensation unit 43 and the phase retardation of the blue light passing through the liquid crystal layer in the display panel is an integer multiple of the wavelength of the blue light. In an exemplary embodiment, the second liquid crystal polymer layer is made of the same material as the third liquid crystal polymer layer, and since the wavelength of green light is larger than the wavelength of blue light, the thickness of the second compensation unit 42 can be set to be larger than the thickness of the third compensation unit 43.

In some possible implementations, after the polymer liquid crystal composite film is formed and before the heat treatment or ultraviolet irradiation treatment, the polymer liquid crystal composite film can be irradiated with linearly polarized ultraviolet light so that the optical axis direction of the liquid crystal molecules in the polymer liquid crystal composite film is parallel to the set direction, wherein the set direction is the initial optical axis direction of the liquid crystal molecules in the liquid crystal layer of the display panel. After the liquid crystal is polymerized, the optical axis direction of the liquid crystal molecules will not change, which is different from the liquid crystal layer in the display panel. In some possible implementations, before manufacturing the compensation layer, the method may include the acts of forming an alignment film and performing rubbing treatment on the alignment film. In some possible implementations, the alignment film can be formed and rubbed, and then the first compensation unit 41, the second compensation unit 42 and the third compensation unit 43 can be formed in sequence. In the process of forming the compensation units in sequence, the corresponding polymer liquid crystal composite film is formed and then the linearly polarized ultraviolet irradiation treatment is performed.

In some possible implementations, the wavelength of linearly polarized ultraviolet light may be 300 nm to 370 nm. Heating may include pre-baking and post-baking, the pre-baking process may include holding at 50° C. to 130° C. for 0.5 min to 10 min, and the post-baking process may include holding at 150° C. to 240° C. for 10 min to 40 min. The ultraviolet irradiation treatment may include the first ultraviolet irradiation and the second ultraviolet irradiation. The first ultraviolet irradiation process may include ultraviolet irradiation with a wavelength of 365 nm and a light intensity of 0.5 mw/cm2 to 600 mw/cm2 for 0.5 min to 60 min, and the second ultraviolet irradiation process may include ultraviolet irradiation with a wavelength of 254 nm and a light intensity of 0.5 mw/cm2 to 600 mw/cm2 for 0.5 min to 60 min. In some possible implementations, various combinations of baking and ultraviolet irradiation can be used to treat the polymer liquid crystal composite film. For example, a pre-baking process and a post-baking process are sequentially performed, or a first ultraviolet irradiation process and a second ultraviolet irradiation process are sequentially performed. Another example is that the pre-baking process, the first ultraviolet irradiation and the post-baking process are carried out in sequence. For another example, the pre-baking process, the first ultraviolet irradiation and the second ultraviolet irradiation are sequentially performed, and the baking parameters (such as temperature and time) and ultraviolet parameters (such as wavelength, light intensity and time) can be adjusted according to the combination, which is not limited in the present disclosure.

In some possible implementations, the materials of the polymer liquid crystal composite film can include liquid crystal, liquid crystalline polymerized monomer, polymerized monomer and initiator. In some possible implementations, in the material of polymer liquid crystal composite film, the weight percentage of liquid crystal can be 20% to 45%, the weight percentage of liquid crystal polymerized monomer can be 5% to 35%, the weight percentage of polymerized monomer can be 0.05 to 19.5%, and the weight percentage of initiator can be 0.05% to 0.5%.

In an exemplary embodiment, the liquid crystal can adopt small molecular nematic liquid crystal, including but not limited to any one or more of MAT-1370, MAT-1284, LCCC-17-435 and LCCC-17-1243. The polymerized monomer can be thermally polymerized monomer or ultraviolet polymerized monomer, including but not limited to any one or more of polyethylene glycol diglycidyl ether, bisphenol F epoxy resin, trimethylolpropane triglycidyl ether and quaternary tetraol glycidyl ether. The initiator can be thermal initiator or photoinitiator, including but not limited to any one or more of IRG 651 benzoin and its derivatives, benzil and benzophenone. The additive can be any one or more of boron fluoride bipyrrole fluorescent dyes, ethidium bromide and rhodamine.

In an exemplary embodiment, any one or more of the compounds having the following chemical formula can be used as the liquid crystal polymerized monomer:

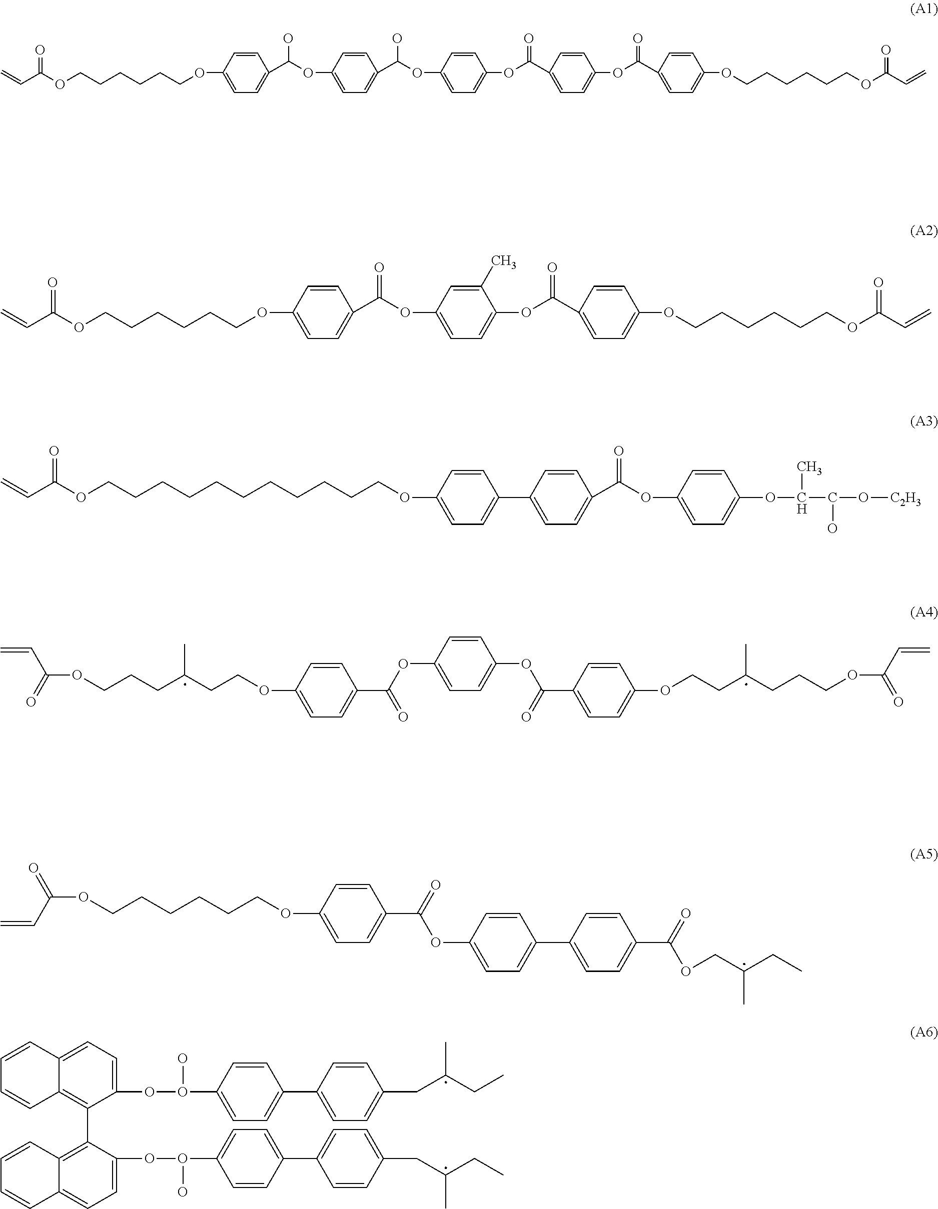

In some possible implementations, polyethylene glycol diglycidyl ether can be a compound with the following chemical formula:

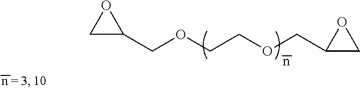

Bisphenol F epoxy resin can be a compound with the following chemical formula:

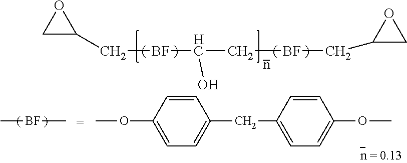

Trimethylolpropane triglycidyl ether can be a compound with the following chemical formula:

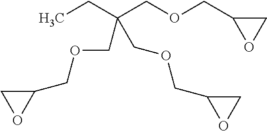 [SMILES: CCC(COCC1CO1)(COCC1CO1)COCC1CO1]

Quaternary tetraol glycidyl ether can be a compound with the following chemical formula:

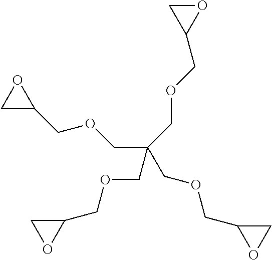 [SMILES: C(OCC(COCC1CO1)(COCC1CO1)COCC1CO1)C1CO1]

Thus, the manufacture of the opposite substrate is completed. The first method for manufacturing a compensation layer in this embodiment is to manufacture three compensation units in turn, which are made of the same material but are of different thicknesses. The three compensation units are made into different thicknesses by adjusting the coating thickness, and the manufacture process is mature.

A second method for manufacturing a compensation layer may include: steps (321), (322), (323), and (324).

(321): The first compensation unit 41 is formed by the first manufacture method. A polymer liquid crystal composite film is coated on the opposite substrate 20, a liquid crystal polymer layer is formed by heating or ultraviolet irradiation, and the liquid crystal polymer layer is exposed and developed by using a mask plate to form a first compensation unit 41 on the red color filter unit, as shown in FIG. 4. In some possible implementations, the polymerization degree of liquid crystal molecules can be adjusted by adjusting the heating temperature and heating time of heat treatment, ultraviolet wavelength of ultraviolet irradiation treatment, ultraviolet irradiation intensity and irradiation time. and then the refractive index nx in the X-axis direction and the refractive index ny in the Y-axis direction of the first compensation unit 41 can be adjusted, and the phase retardation of the red light passing through the first compensation unit 41 can be adjusted so that the sum of the phase retardation of the red light passing through the first compensation unit 41 and the phase retardation of the red light passing through the liquid crystal layer in the display panel is an integer multiple of the wavelength of the red light.

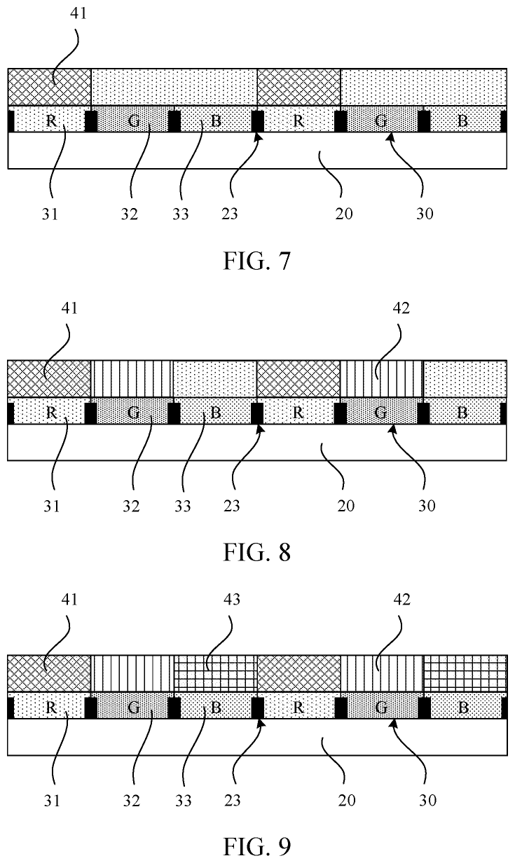

(322): A layer of polymer liquid crystal composite film containing ultraviolet polymerized monomer and thermally polymerized monomer is coated on the opposite substrate 20 with the aforementioned structure formed, and the polymer liquid crystal composite film is located on the color filter layer 30 between adjacent first compensation units 41, as shown in FIG. 7. In an exemplary embodiment, the material of the polymer liquid crystal composite film may include liquid crystal, liquid crystal polymerized monomer, thermally polymerized monomer, ultraviolet polymerized monomer and initiator. In some possible implementations, in the material of polymer liquid crystal composite film, the weight percentage of liquid crystal can be 20% to 39.5%, the weight percentage of liquid crystal polymerized monomer can be 5% to 20%, the weight percentage of ultraviolet polymerized monomer can be 5% to 20%, the weight percentage of thermally polymerized monomer can be 5% to 20%, and the weight percentage of initiator can be 0.05% to 0.5%.

(323): The polymer liquid crystal composite film in the area corresponding to the green color filter unit is irradiated with ultraviolet light by the mask plate, that is, only the area corresponding to the green color filter unit is irradiated by the mask plate, so that the ultraviolet polymerized monomer in the irradiated polymer liquid crystal composite film is polymerized in the diffusion process to form the second compensation unit 42, as shown in FIG. 8. In an exemplary embodiment, the ultraviolet irradiation process may include irradiating with ultraviolet light with a wavelength of 365 nm and an intensity of 0.5 mw/cm2 to 600 mw/cm2 for 0.5 min to 60 min. In some possible implementations, by adjusting the wavelength, irradiation intensity and irradiation time of ultraviolet light, the concentration gradient of ultraviolet polymerized monomer can be adjusted, and then the refractive index nx in the X-axis direction and the refractive index ny in the Y-axis direction of the second compensation unit 42 can be adjusted, and the phase retardation of the green light passing through the second compensation unit 42 can be adjusted so that the sum of the phase retardation of the green light passing through the second compensation unit 42 and the phase retardation of the green light passing through the liquid crystal layer in the display panel is an integer multiple of the wavelength of the green light.

(324): The mask plate is removed, and the opposite substrate 20 with the above structure is set on the heating pedestal or in the oven for thermal polymerization to polymerize the thermally polymerized monomer in the polymer liquid crystal composite film in the region corresponding to the blue color filter unit to form the third compensation unit 43, as shown in FIG. 9. In an exemplary embodiment, the thermal polymerization process may include staying at 80° C. to 250° C. for 10 to 60 minutes. In some possible implementations, by adjusting the heating temperature and heating time, the degree of polymerization of the thermally polymerized monomer can be adjusted, and then the refractive index nx in the X-axis direction and the refractive index ny in the Y-axis direction of the third compensation unit 43 can be adjusted, and the phase retardation of the blue light passing through the third compensation unit 43 can be adjusted so that the sum of the phase retardation of the blue light passing through the third compensation unit 43 and the phase retardation of the blue light passing through the liquid crystal layer in the display panel is an integer multiple of the wavelength of the blue light.

In some possible implementations, a first compensation unit, a second compensation unit and a third compensation unit have a same thickness. For example, the thickness of the first compensation unit, the second compensation unit and the third compensation unit may be 0.5 μm to 3.0 μm. The first compensation unit is manufactured by the first manufacture method, which is convenient to adjust its refractive index parameters. Because the second compensation unit and the third compensation unit adopt different polymerization methods, the material composition in the two compensation units is different, and the refractive index parameters of the two compensation units are thus also different, making the refractive index difference of the first compensation unit 41 larger than the refractive index difference of the second compensation unit 42 and the refractive index difference of the second compensation unit 42 larger than that of the third compensation unit 43. As the three compensation units in this embodiment have the same thickness, they can be reused as planarization layers, which reduce the complexity of the process of manufacturing the opposite substrate and are conducive for saving the production cost of products.

In some possible implementations, after coating the polymer liquid crystal composite film and before irradiating with ultraviolet light, the act of rubbing treatment may be included. The polymer liquid crystal composite film is irradiated with linearly polarized ultraviolet light so that the optical axis direction of liquid crystal molecules in the polymer liquid crystal composite film is parallel to the set direction. In some possible implementations, before manufacturing the compensation layer, the method may include the acts of forming an alignment film and performing rubbing treatment on the alignment film.

Thus, the manufacture of the opposite substrate is completed. The second method for manufacturing the compensation layer in this embodiment is to manufacture one compensation unit through conventional process, and then the other two compensation units are manufactured simultaneously by using the polymer liquid crystal composite film containing ultraviolet polymerize monomer and thermally polymerized monomer. It not only has simple manufacture process and short process time, but also simplifies the material sources and reduces the manufacturing cost.

A third method for manufacturing a compensation layer may include: a manufacture method which is an extension of the first method for manufacturing the compensation layer, and the main manufacture flow is basically the same as that of the first method for manufacturing the compensation layer, except that the materials of the three compensation units are different while the thicknesses of the three compensation units are the same.

In the exemplary embodiment, the third method for manufacturing the compensation layer include: steps (331), (332), and (333).

(331): a first polymer liquid crystal composite film is coated, a first liquid crystal polymer layer is formed by heat treatment or ultraviolet irradiation treatment, and the first liquid crystal polymer layer is exposed and developed by using a mask plate to form the first compensation unit 41.

(332): A second polymer liquid crystal composite film is coated, a second liquid crystal polymer layer is formed by heat treatment or ultraviolet irradiation treatment, and the second liquid crystal polymer layer is exposed and developed by using a mask plate to form a second compensation unit 42. The first liquid crystal polymer layer and the second liquid crystal polymer layer have different materials, and the second compensation unit 42 and the first compensation unit 41 have the same thickness.

(333): A third polymer liquid crystal composite film is coated, a third liquid crystal polymer layer is formed by heat treatment or ultraviolet irradiation treatment, and the third liquid crystal polymer layer is exposed and developed by using a mask plate to form a third compensation unit 43. The third liquid crystal polymer layer and the second liquid crystal polymer layer have different materials, and third liquid crystal polymer layer 43 and the second liquid crystal polymer layer 42 have the same thickness.

Thus, the manufacture of the opposite substrate is completed. The third method for manufacturing the compensation layer is to manufacture three compensation units in turn. The thickness of the three compensation units is the same, but the materials used are different. By adjusting the materials, the three compensation units have different refractive index parameters. In some possible implementations, the third method for manufacturing the compensation layer may be that the materials and thicknesses of the three compensation units are different.

In some possible implementations, the manufacture method for the opposite substrate may further include forming a planarization layer (OC), an alignment film and performing alignment treatment on the alignment film.

III. Part II

The cell aligning process includes: a sealing body is coated on the non-display area of the array substrate, liquid crystal is dripped on the display area of the array substrate, the opposite substrate and the array substrate relatively close to each other are aligned and pressed under vacuum condition, and the sealant is cured by any one or more of ultraviolet curing and heat curing, thus completing the cell aligning process to form the display panel. In some possible implementations, the sealant may be coated on the array substrate or on the opposite substrate. The liquid crystal can be dripped on the array substrate or on the opposite substrate, which is not limited in the present disclosure.

The manufacture process of the display panel mentioned above is only an exemplary illustration. In practice, the array substrate and the opposite substrate can be manufactured by other methods. For example, adjusting the compensation unit thickness parameter in the first compensation layer manufacture method and adjusting the compensation unit refractive index parameter in the second compensation layer manufacture method can be combined to adjust the compensation unit phase retardation value by adjusting the compensation unit thickness parameter and refractive index parameter, or one or two compensation units adopt the thickness parameter and the other two or one compensation units adopt the refractive index parameter. For another example, in the second method for manufacturing the compensation layer, two compensation units can be manufactured simultaneously by using the polymer liquid crystal composite film, and then another compensation unit can be manufactured by using the conventional process. For another example, in the second method for manufacturing the compensation layer, a separately manufactured compensation unit can adopt a polymer liquid crystal composite film containing ultraviolet polymerized monomer or a polymer liquid crystal composite film containing thermally polymerized monomer, and the present disclosure is not limited here.

According to the structure of the display panel and its manufacture process, it can be seen that by providing three compensation units respectively compensating the phases of the light of three colors, when the polarization state of the transmitted light changes due to uneven external force on the display panel, the phase retardations of the light of three colors through the three compensation units can match the phase retardations of the liquid crystal layer, thereby compensating the phase retardations of the three color polarized light through the liquid crystal layer. In this way, each color light can be restored to the original polarization state, and each color light cannot be emitted from the horizontally oriented display panel in the dark state, which not only effectively improves the problems of light leakage and empurple in the dark state, but also effectively improves the problem of color cast.

In the related art, although there is a proposal to provide a compensation film layer between the array substrate and the opposite substrate, a standard wavelength, such as 550 nm, is often set in the visible wavelength range, so that the sum of the phase retardation of the incident white light passing through the compensation film layer and the phase retardation of the white light passing through the liquid crystal layer is equal to an integer multiple of 550 nm. Although the related schemes have improved the light leakage in dark state to a certain extent, they cannot solve the problems of empurple or color cast in dark state. In fact, the related schemes only reduce the light leakage in a certain wavelength range (such as 550 nm), which further reduces the overall light leakage. However, because there is still light leakage in other wavelength ranges, the related schemes aggravate the problems of dark state empurple and color cast when improving dark light leakage. In contrast, embodiments of the present disclosure provide three compensation units to compensate the phases of light of three colors respectively, which not only reduces the light leakage in a larger wavelength range, but also improves the dark light leakage problem to the greatest extent. Moreover, each color reduces the light leakage by the same amount, achieving the color cast compensation of the three colors, thus effectively improving the dark state empurple and color cast problems, and further achieving no dispersion and improving the LO picture quality. The scheme of this embodiment breaks the bottleneck that the ADS display mode curved surface is limited, and increases the feasibility of applying ADS display mode to curved surface products. The process flow for manufacturing the display panel in this embodiment is basically the same as that of related manufacture processes, which can be achieved by using mature manufacture equipment, with little process improvement, high compatibility, simple process realization, and easy implementation, and therefore has a good application prospect.

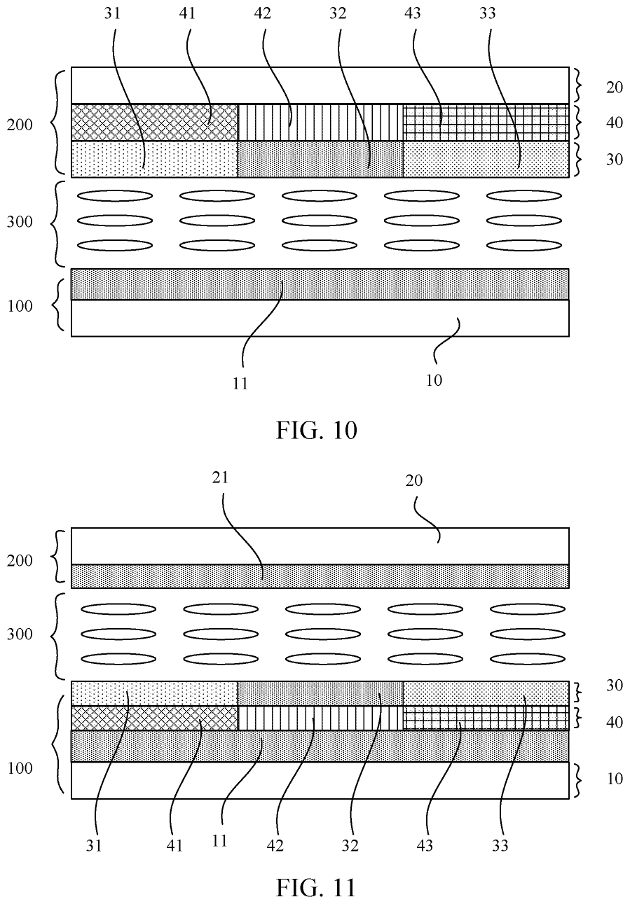

FIG. 10 is a schematic diagram of another structure of a display panel according to an embodiment of the present disclosure, illustrating a structure in which a color filter layer and a compensation layer are arranged on one side of an opposite substrate. This embodiment is an extension of the previous embodiment. The main structure of the display panel is basically the same as that of the previous embodiment. The display panel includes an array substrate 100 and an opposite substrate 200 that are arranged opposite to each other, and a liquid crystal layer 300 arranged between the array substrate 100 and the opposite substrate 200. The array substrate 100 includes an array base substrate 10 and an array structure layer 11 arranged on the surface of the array substrate 10 facing the opposite substrate 200, and the opposite substrate 200 includes an opposite substrate 20, a color filter layer 30 and a compensation layer 40. As shown in FIG. 10, unlike the previous embodiments, the compensation layer 40 of this embodiment is arranged on the surface of the opposite substrate 20 facing the array substrate 100, and the color filter layer 30 is arranged on the surface of the compensation layer 40 facing the array substrate 100.

FIG. 11 is a schematic diagram of yet another structure of a display panel according to an embodiment of the present disclosure, illustrating a structure in which a color filter layer and a compensation layer are arranged on one side of the array substrate. This embodiment is an extension of the previous embodiment. The main structure of the display panel is basically the same as that of the previous embodiment. The display panel includes an array substrate 100 and an opposite substrate 200 which are oppositely arranged, and a liquid crystal layer 300 arranged between the array substrate 100 and the opposite substrate 200. As shown in FIG. 11, unlike the previous embodiments, the color filter layer 30 and the compensation layer 40 of this embodiment are arranged on the surface of the array substrate 100 facing an opposite substrate 20. Illustratively, the opposite substrate 200 includes an opposite substrate 20 and an opposite structure layer 21 arranged on the surface of the opposite substrate 20 facing the array substrate 100. The array substrate 100 includes an array base substrate 10, an array structure layer 11 arranged on the surface of the array base substrate 10 facing the opposite substrate 200, a compensation layer 40 arranged on the surface of the array structure layer 11 facing the opposite substrate 200, and a color filter layer 30 arranged on the surface of the compensation layer 40 facing the opposite substrate 200. In some possible implementations, the color filter layer 30 can be provided on the array structure layer 11, and the compensation layer 40 can be provided on the color filter layer 30.

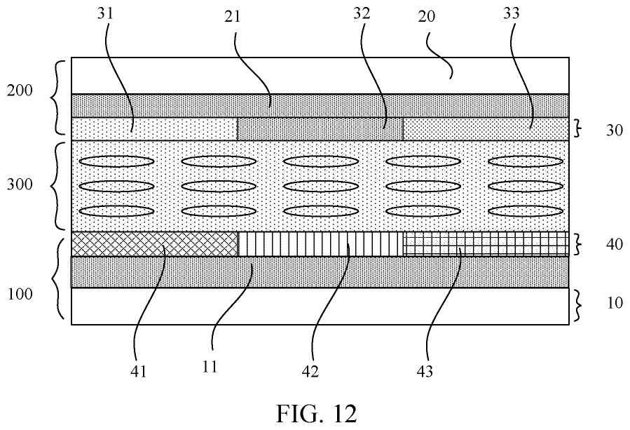

FIG. 12 is a schematic diagram of yet another structure of a display panel according to an embodiment of the present disclosure, illustrating a structure in which a color filter layer is arranged on one side of the opposite substrate and the compensation layer is arranged on one side of the array substrate. This embodiment is an extension of the previous embodiment. The main structure of the display panel is basically the same as that of the previous embodiment. The display panel includes an array substrate 100 and an opposite substrate 200 which are oppositely arranged, and a liquid crystal layer 300 arranged between the array substrate 100 and the opposite substrate 200. As shown in FIG. 12, unlike the previous embodiments, the color filter layer 30 of this embodiment is arranged on the surface of the opposite substrate 200 facing the array substrate 100, and the compensation layer 40 is arranged on the surface of the array substrate 100 facing the opposite substrate 200. Illustratively, the opposite substrate 200 includes an opposite substrate 20, an opposite structure layer 21 arranged on the surface of the opposite substrate 20 facing the array substrate 100, and a color filter layer 30 arranged on the surface of the opposite structure layer 21 facing the array substrate 100. The array substrate 100 includes an array base substrate 10, an array structure layer 11 arranged on the surface of the array substrate 10 facing the opposite substrate 200, and a compensation layer 40 arranged on the surface of the array structure layer 11 facing the opposite substrate 200. In some possible implementations, the compensation layer 40 can be arranged on the surface of the opposite structure layer 21 facing the array substrate 100, and the color filter layer 30 can be arranged on the surface of the array structure layer 11 facing the opposite substrate 200.

The structures shown in FIGS. 10 to 12 also achieve the technical effects of the previous embodiments, effectively improving not only light leakage and empurple in dark state, but also the color cast.

Based on the technical idea of the foregoing embodiments, an embodiment of present disclosure further provides a method for manufacturing a display panel. The manufacture method of the display panel may include: S1 and S2.

In S1, an array substrate and an opposite substrate are respectively manufactured, wherein a color filter layer and a compensation layer are formed on the array substrate or the opposite substrate.

In S2, a liquid crystal layer is formed between the array substrate and the opposite substrate.

The color filter layer includes n color filter units that are periodically arranged, the compensation layer includes n compensation units that are periodically arranged, and the direction of the optical axis of the n compensation units is parallel to the direction of the initial optical axis of the liquid crystal molecules in the liquid crystal layer; and the ith color filter unit is configured to filter out the light of an ith color, wherein the position of an ith color filter unit corresponds to the position of an ith compensation unit; and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color; n is a positive integer greater than 2, and i=1, 2, . . . , n.

In an exemplary embodiment, the color filter layer and the compensation layer are formed on the opposite substrate, and the manufacture of the opposite substrate in Act S1 includes: sequentially manufacturing a color filter layer and a compensation layer on the opposite substrate, or sequentially manufacturing a compensation layer and a color filter layer on the opposite substrate.

In the exemplary embodiment, manufacturing the compensation layer may include: forming a polymer liquid crystal composite film, forming a liquid crystal polymer layer by heating or ultraviolet irradiation, and exposing and developing the liquid crystal polymer layer by using a mask plate to form a first compensation unit; coating a polymer liquid crystal composite film containing ultraviolet polymerized monomer and thermally polymerized monomer, and irradiating the polymer liquid crystal composite film with ultraviolet light by using a mask plate to form a second compensation unit; and setting the opposite substrate on a heating pedestal or in an oven, and heating the polymer liquid crystal composite film to form a third compensation unit.

In an exemplary embodiment, the n color filter units may include a red color filter unit, a green color filter unit and a blue color filter unit; the n compensation units may include a first compensation unit corresponding to the position of the red color filter unit, a second compensation unit corresponding to the position of the green color filter unit and a third compensation unit corresponding to the position of the blue color filter unit; wherein, the phase retardation of the red light passing through the first compensation unit is greater than the phase retardation value of the green light passing through the second compensation unit, and the phase retardation of the green light passing through the second compensation unit is greater than the phase retardation of the blue light passing through the third compensation unit.

In an exemplary embodiment, in a direction perpendicular to the display panel, the thicknesses of the first compensation unit, the second compensation unit and the third compensation unit are the same; the refractive index difference of the first compensation unit is greater than the refractive index difference of the second compensation unit, and the refractive index difference of the second compensation unit is greater than the refractive index difference of the third compensation unit.

In an exemplary embodiment, the thickness of the compensation layer may be about 0.5 μm to 3.0 μm.

In an exemplary embodiment, the refractive index differences of the first compensation unit, the second compensation unit and the third compensation unit are the same, and in the direction perpendicular to the display panel, the thickness of the first compensation unit is greater than the thickness of the second compensation unit, and the thickness of the second compensation unit is greater than the thickness of the third compensation unit.

The process for manufacturing the display panel has been described in detail in the previous embodiments and will not be repeated here.

An embodiment of the present disclosure provides a manufacturing method of a display panel. By providing multiple compensation units respectively compensating the phases of light of multiple colors, when the polarization state of the transmitted light changes due to uneven external force on the display panel, the phase retardations of the light of multiple colors through the multiple compensation units can match the phase retardations of the liquid crystal layer, thereby compensating the phase retardations of the polarized light of multiple colors through the liquid crystal layer. In this way, each color light can be restored to the original polarization state, and each color light cannot be emitted from the horizontally oriented display panel in the dark state, which not only effectively improves the problems of light leakage and empurple in the dark state, but also effectively improves the problem of color cast. The process for manufacturing the display panel may be achieved by using mature manufacturing equipment, with little process improvement, high compatibility, simple process realization, and easy implementation, and therefore has a good application prospect.

An embodiment of the present disclosure further provides a display apparatus, including the horizontal electric field display panel described above. The display apparatus may be any product or component with a display function such as a mobile phone, a tablet computer, a television, a display, a laptop computer, a digital photo frame, a navigator, etc.

Although the implementations of the present disclosure are disclosed above, the contents are only implementations adopted to easily understand the present disclosure and are not intended to limit the present disclosure. Those skilled in the art may make any modifications and variations to implementation forms and details without departing from the spirit and scope disclosed by the present disclosure. However, the scope of patent protection of the present disclosure should also be subject to the scope defined by the appended claims.

1. A display panel, comprising: an array substrate and an opposite substrate that are arranged opposite to each other, and a liquid crystal layer provided between the array substrate and the opposite substrate; wherein
a color filter layer and a compensation layer are provided on the array substrate or the opposite substrate;
the color filter layer comprises n color filter units that are periodically arranged, the compensation layer comprises n compensation units that are periodically arranged, and the direction of the optical axis of the n compensation units is parallel to the direction of the initial optical axis of the liquid crystal molecules in the liquid crystal layer; and
the ith color filter unit is configured to filter out the light of an ith color, wherein the position of an ith compensation unit corresponds to the position of an ith color filter unit, and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color; wherein n is a positive integer greater than 2, and i=1, 2, . . . , n.

2. The display panel of claim 1, wherein the color filter layer is arranged on a side of the array substrate facing the opposite substrate, or the color filter layer is arranged on a side of the opposite substrate facing the array substrate.

3. The display panel of claim 1, wherein the compensation layer is arranged on a side of the array substrate facing the opposite substrate, or the compensation layer is arranged on a side of the opposite substrate facing the array substrate.

4. The display panel of claim 1, wherein
the color filter layer is arranged on a side of the opposite substrate facing the array substrate, and the compensation layer is arranged on a side of the color filter layer facing the array substrate; or
the compensation layer is arranged on a side of the opposite substrate facing the array substrate, and the color filter layer is arranged on a side of the compensation layer facing the array substrate.

5. The display panel of claim 1, wherein the compensation layer comprises a positive double zigzag uniaxial plate.

6. The display panel of claim 5, wherein
the materials of the positive double zigzag uniaxial plate comprise: 20% to 45% by weight of liquid crystal, 5% to 35% by weight of liquid crystal polymerized monomer, 0.05% to 19.5% by weight of polymerized monomer, and 0.05% to 0.5% by weight of initiator; or
the material of the positive double zigzag uniaxial plate comprises: 20% to 39.5% by weight of liquid crystal, 5% to 20% by weight of liquid crystal polymerized monomer, 5% to 20% by weight of ultraviolet polymerized monomer, 5% to 20% by weight of thermally polymerized monomer, and 0.05% to 0.5% by weight of initiator.

7. The display panel of claim 1, wherein
the n color filter units comprise: a red color filter unit that filters out red light, a green color filter unit that filters out green light, and a blue color filter unit that filters out blue light;
the n compensation units comprise a first compensation unit corresponding to the position of the red color filter unit, a second compensation unit corresponding to the position of the green color filter unit, and a third compensation unit corresponding to the position of the blue color filter unit; and
the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.

8. The display panel of claim 7, wherein
in a direction perpendicular to the display panel, the thicknesses of the first compensation unit, the second compensation unit and the third compensation unit are the same; and
the refractive index difference of the first compensation unit is greater than the refractive index difference of the second compensation unit, and the refractive index difference of the second compensation unit is greater than the refractive index difference of the third compensation unit.

9. The display panel of claim 7, wherein
the refractive index differences of the first compensation unit, the second compensation unit and the third compensation unit are the same, and in the direction perpendicular to the display panel, the thickness of the first compensation unit is greater than the thickness of the second compensation unit, and the thickness of the second compensation unit is greater than the thickness of the third compensation unit.

10. A display apparatus, comprising the display panel of claim 1.

11. A method for manufacturing a display panel, comprising:
respectively manufacturing an array substrate and an opposite substrate, wherein a color filter layer and a compensation layer are formed on the array substrate or the opposite substrate; and
forming a liquid crystal layer between the array substrate and the opposite substrate; wherein
the color filter layer comprises n color filter units which are periodically arranged;
the compensation layer comprises n compensation units arranged periodically, and the direction of the optical axis of the n compensation units is parallel to the direction of the initial optical axis of the liquid crystal molecules in the liquid crystal layer; and
the ith color filter unit is configured to filter out the light of an ith color, wherein the position of an ith color filter unit corresponds to the position of an ith compensation unit; and the ith compensation unit is configured to enable the sum of the phase retardation of the light of an ith color passing through the ith compensation unit and the phase retardation of the light of the ith color passing through the liquid crystal layer is an integer multiple of the wavelength of the light of the ith color; wherein n is a positive integer greater than 2, and i=1, 2, . . . , n.

12. The manufacturing method of claim 11, wherein the color filter layer and the compensation layer are formed on the opposite substrate, and manufacturing the opposite substrate comprises:
sequentially manufacturing a color filter layer and a compensation layer on the opposite substrate, or sequentially manufacturing a compensation layer and a color filter layer on the opposite substrate.

13. The manufacturing method of claim 12, wherein manufacturing the compensation layer comprises:
forming a polymer liquid crystal composite film, forming a liquid crystal polymer layer by heating or ultraviolet irradiation, and exposing and developing the liquid crystal polymer layer by using a mask plate to form a first compensation unit;
coating a polymer liquid crystal composite film containing ultraviolet polymerized monomer and thermally polymerized monomer, and irradiating the polymer liquid crystal composite film with ultraviolet light by using a mask plate to form a second compensation unit; and
setting the opposite substrate on a heating pedestal or in an oven, and heating the polymer liquid crystal composite film to form a third compensation unit.

14. The manufacturing method of claim 11, wherein
the n color filter units comprise: a red color filter unit, a green color filter unit and a blue color filter unit;
the n compensation units comprise a first compensation unit corresponding to the position of the red color filter unit, a second compensation unit corresponding to the position of the green color filter unit and a third compensation unit corresponding to the position of the blue color filter unit; and
the phase retardation of the red light passing through the first compensation unit is greater than the phase retardation value of the green light passing through the second compensation unit, and the phase retardation of the green light passing through the second compensation unit is greater than the phase retardation of the blue light passing through the third compensation unit.

15. The manufacturing method of claim 14, wherein
in a direction perpendicular to the display panel, the thicknesses of the first compensation unit, the second compensation unit and the third compensation unit are the same; the refractive index difference of the first compensation unit is greater than the refractive index difference of the second compensation unit, and the refractive index difference of the second compensation unit is greater than the refractive index difference of the third compensation unit; or
the refractive index differences of the first compensation unit, the second compensation unit and the third compensation unit are the same, and in the direction perpendicular to the display panel, the thickness of the first compensation unit is greater than the thickness of the second compensation unit, and the thickness of the second compensation unit is greater than the thickness of the third compensation unit.

16. The display panel of claim 2, wherein
the n color filter units comprise: a red color filter unit that filters out red light, a green color filter unit that filters out green light, and a blue color filter unit that filters out blue light;
the n compensation units comprise a first compensation unit corresponding to the position of the red color filter unit, a second compensation unit corresponding to the position of the green color filter unit, and a third compensation unit corresponding to the position of the blue color filter unit; and
the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.

17. The display panel of claim 3, wherein
the n color filter units comprise: a red color filter unit that filters out red light, a green color filter unit that filters out green light, and a blue color filter unit that filters out blue light;
the n compensation units comprise a first compensation unit corresponding to the position of the red color filter unit, a second compensation unit corresponding to the position of the green color filter unit, and a third compensation unit corresponding to the position of the blue color filter unit; and
the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.

18. The display panel of claim 4, wherein
the n color filter units comprise: a red color filter unit that filters out red light, a green color filter unit that filters out green light, and a blue color filter unit that filters out blue light;
the n compensation units comprise a first compensation unit corresponding to the position of the red color filter unit, a second compensation unit corresponding to the position of the green color filter unit, and a third compensation unit corresponding to the position of the blue color filter unit; and
the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.

19. The display panel of claim 5, wherein
the n color filter units comprise: a red color filter unit that filters out red light, a green color filter unit that filters out green light, and a blue color filter unit that filters out blue light;
the n compensation units comprise a first compensation unit corresponding to the position of the red color filter unit, a second compensation unit corresponding to the position of the green color filter unit, and a third compensation unit corresponding to the position of the blue color filter unit; and
the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.

20. The display panel of claim 6, wherein
the n color filter units comprise: a red color filter unit that filters out red light, a green color filter unit that filters out green light, and a blue color filter unit that filters out blue light;
the n compensation units comprise a first compensation unit corresponding to the position of the red color filter unit, a second compensation unit corresponding to the position of the green color filter unit, and a third compensation unit corresponding to the position of the blue color filter unit; and
the phase retardation value of the red light passing through the first compensation unit is greater than the phase retardation value of the green light passing through the second compensation unit, and the phase retardation value of the green light passing through the second compensation unit is greater than the phase retardation value of the blue light passing through the third compensation unit.
